(19) United States
(12) Patent Application Publication
(10) Pub. No.: US 2016/0189165 A1
(43) Pub. Date: Jun. 30, 2016

(54) REVIEWING DISPLAYED ADVERTISEMENTS FOR COMPLIANCE WITH ONE OR MORE ADVERTISING POLICIES ENFORCED BY AN ONLINE SYSTEM

(71) Applicant: Facebook, Inc., Menlo Park, CA (US)

(72) Inventor: Ashley Vivlamore, Austin, TX (US)

(21) Appl. No.: 14/586,551

(22) Filed: Dec. 30, 2014

(51) Int. Cl. G06Q 30/00; H04L 29/06; H04L 29/08; G06Q 30/02

(52) U.S. Cl. CPC G06Q 30/018; G06Q 30/0277; H04L 63/20; H04L 67/02; H04L 67/10

(57) ABSTRACT

An online system reviews advertisements for compliance with one or more policies regulating content included in advertisements. To reduce further presentation of non-compliant advertisements, the online system identifies a subset of advertisements previously presented to one or more users of the online system to be again evaluated for compliance with one or more policies enforced by the online system. Previously presented advertisements may be selected for the subset based on a number of times the advertisements were presented to online system users. For example, selection of advertisements for inclusion the subset is weighted by a number of times advertisements were presented to online system users (i.e., the number of impressions of the advertisements). One or more models applied to advertisements to determine whether the advertisements comply with one or more policies may be modified based on evaluation of the previously presented advertisements.

### BACKGROUND

This invention relates generally to online systems, and in particular to reviewing content for compliance with policies enforced by an online system.

An online system, such as a social networking system, allows its users to connect to and communicate with other users. Users of the online system may create user profiles that are maintained by the online system and tied to the users' identities. A user profile includes information about a user, such as interests and demographic information. Establishing connections with other users via the online system allows a user to more easily share content with the other users via the online system.

Because online systems allow users to more easily exchange content with each other, certain users (e.g., businesses, organizations) may present content items to online system users to gain public attention for products or services or to persuade users to take an action regarding provided products or services. Many online systems may receive compensation from a user for presenting certain types of content items provided by the user to other online system users. For example, an online system charges an entity each time certain types of content items are presented to online system users (e.g., each “impression” of the content items) or for each interaction with certain types of content items by online system users (e.g., each time an online system user accesses a certain type of content item).

As an increasing number of users interact with an online system, a number of content items for which the online system receives compensation for presenting also increases. To present content to a user of the online system with which the user is likely to interact, the online system may enforce one or more policies regulating content included in content items for which the online system receives compensation for presenting. The online system may enforce the one or more policies by reviewing content items for compliance with the one or more policies before allowing the content items to be presented to users. Manual review of content items for compliance with policies is a time consuming process and difficult to scale as the number of content items for which the online system receives compensation for presenting increases. Hence, many online systems apply trained models to content items to determine whether the content items comply with one or more policies enforced by an online system before presenting the content items to online system users. However, determining compliance with one or more policies enforced by an online system through application of one or more trained models can result in a higher error rate than determining compliance with one or more policies through manual review of content items, which may result in presentation of content items that do not comply with one or more enforced policies to online system users.

### SUMMARY

An online system generates revenue by presenting advertisements to its users. To enhance user experience, the online system enforces one or more policies regulating content included in an advertisement. Hence, advertisements presented by the online system are limited to advertisements complying with the one or more policies enforced by the online system. Reviewing the advertisements for compliance with the one or more policies may be time consuming. While conventional online systems may manually review advertisements for compliance with one or more policies enforced by the online systems, the time to approve an advertisement as complying with enforced policies may vary depending on multiple factors (e.g., complexity of the advertisement, reviewer backlog). This may reduce the number of advertisements presented by the online system during certain time intervals, resulting in lower revenues for the online system.

While one or more trained models may be applied to advertisements by the online system to determine whether the advertisements comply with one or more policies enforced by the online system, trained models may be less accurate than manual review of advertisements. Hence, when trained models are applied to advertisements, some advertisements that do not comply with policies enforced by the online system may erroneously be presented to users. Further, policies enforced by the online system may change after the advertisement was initially reviewed for compliance with the one or more policies enforced by the online system, leading to advertisements that are not compliant with the updated one or more policies enforced by the online system to still be presented to users. Additionally, policies enforced by the online system may change more frequently than the trained models are updated or modified, so the trained models may evaluate advertisements for compliance with policies of the online system differing from the most current policies.

To more accurately determine whether advertisements being shown to users comply with the current policies enforced by the online system, advertisements previously presented to users of the online system are identified and evaluated for compliance for the policies enforced by the online system. Each time an advertisement is presented to an online system user, the online system identifies an impression of the advertisement. When selecting previously presented advertisements for evaluation against policies enforced by the online system, the online system accounts for numbers of impressions of various previously presented advertisements. For example, a probability of selecting a previously presented advertisement is proportional to a number of impressions of the previously presented advertisements, so previously presented advertisements with a larger number of impressions are more likely to be selected. This increases the likelihood of the online system evaluating advertisements that have previously been presented to a larger number of users for compliance with policies enforced by the online system.

Based on the numbers of impressions of various previously presented advertisements, the online system selects a subset of the previously presented advertisements and evaluates advertisements in the subset of previously presented advertisements for compliance with one or more policies enforced by the online system. Results from evaluating the advertisements in the subset for compliance with the one or more policies enforced by the online system may be used to generate a report. Results from evaluating the advertisements in the subset for compliance with the one or more policies may also be used to modify one or more models applied to advertisements by the online system to determine whether the advertisements comply with one or more policies enforced by the online system. Additionally, advertisements from the subset determined to violate one or more policies may be analyzed to identify components of advertisements that violate policies enforced by the online system. Additionally, advertisements from the subset determined to violate one or more policies may be automatically removed or flagged for removal from the group of advertisements that continue to be presented to users.

### BRIEF DESCRIPTION OF THE DRAWINGS

FIG. 1 is a block diagram of a system environment for approving advertisements in an online system, in accordance with an embodiment.

FIG. 2 is a block diagram of a system architecture of an online system for evaluating advertisements, in accordance with an embodiment.

FIG. 3 is a process flow diagram illustrating selection of advertisements for evaluation against a policy based on advertisement impressions, according to one embodiment.

FIG. 4 is a flowchart of a method for reviewing previously presented advertisements in an online system, in accordance with one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

An online system reviews advertisements for compliance with one or more policies regulating content included in advertisements. While the online system reviews advertisements before presenting the advertisements to users, certain advertisements may not be identified as violating one or more of the policies, causing presentation of non-compliant advertisements to online system users. To reduce further presentation of non-compliant advertisements, the online system identifies a subset of advertisements previously presented to one or more users of the online system to be again evaluated for compliance with one or more policies enforced by the online system. Previously presented advertisements may be selected for the subset based on a number of times the advertisements were presented to online system users. For example, selection of advertisements for inclusion the subset is weighted by a number of times advertisements were presented to online system users (i.e., the number of impressions of the advertisements). In some embodiments, the subset of advertisements is presented to one or more human reviewers for evaluation against the one or more policies enforced by the online system. Based on evaluation of advertisements in the subset against the one or more policies, the online system may modify one or more models applied to advertisements to determine whether the advertisements comply with one or more policies or identify components of advertisements that do not comply with policies enforced by the online system.

### Ad Review System Environment

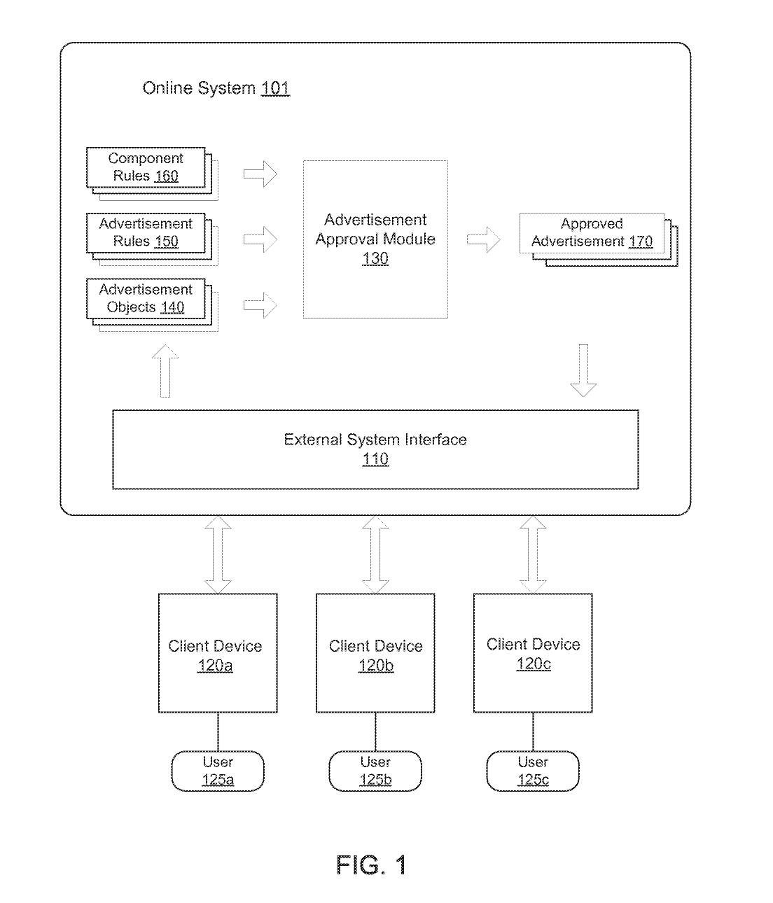

FIG. 1 is a diagram of one embodiment of a system environment for approving advertisements for presentation by an online system 101. FIG. 1 and the other figures use like reference numerals to identify like elements. A letter after a reference numeral, such as “120A,” indicates that the text refers specifically to the element having that particular reference numeral. A reference numeral in the text without a following letter, such as “120,” refers to any or all of the elements in the figures bearing that reference numeral (e.g., “120” in the text refers to reference numerals “120A” and/or “120B” in the figures).

Users 125a, 125b, 125c interact with the online system 101 using client devices 120a, 120b, 120c. A client device 120 may be any computing device having data processing and data communication capabilities. Examples of client devices 120 include a desktop computer, a laptop computer, a tablet computer, a smart phone, a personal digital assistant (PDA), or other suitable computing device.

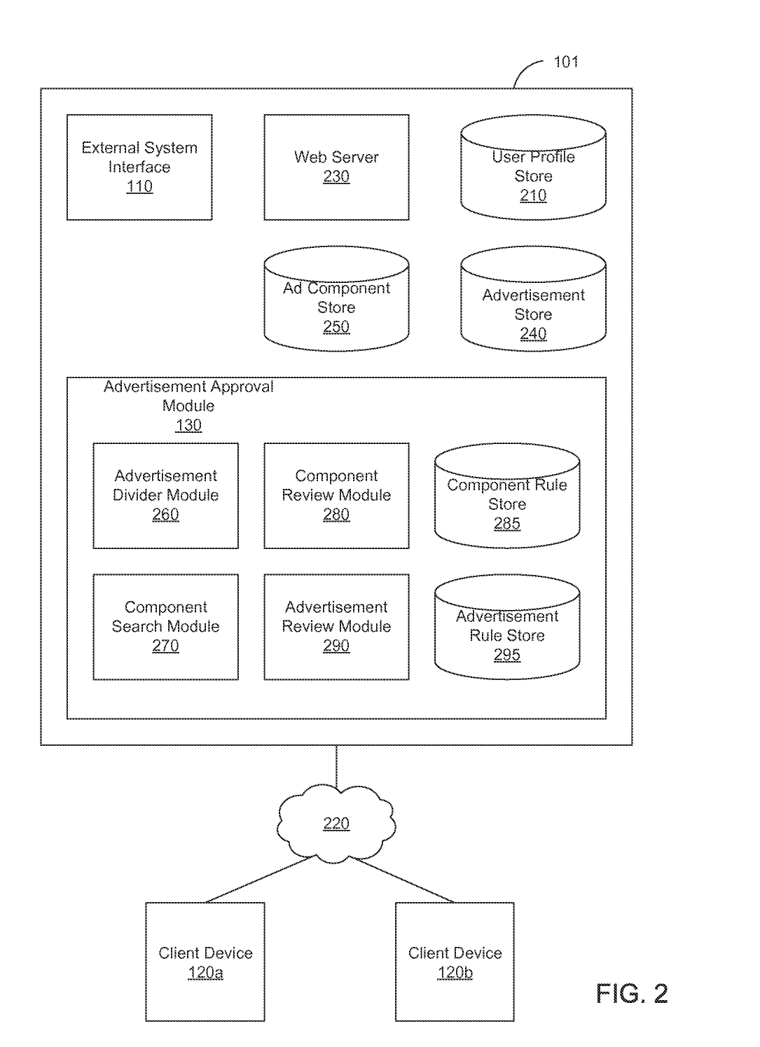

In one embodiment, the online system 101 includes an external system interface 110 for transmitting and receiving data between the online system 101 and one or more client devices 120. The online system 101 maintains different types of objects representing data for use in creating and presenting advertisements. Examples objects maintained by the online system 101 include advertisement objects 140, advertisement rules 150, component rules 160, and approved advertisement objects 170. An advertisement object 140 stores information describing advertisements provided to the online system 101 form one or more advertisers. In some embodiments, an advertisement comprises multiple components, which are also included in an advertisement object 140 corresponding to the advertisement. An advertisement rule object 150 stores information describing one or more policies enforced by the online system 101 to regulate content included in an advertisement. Advertisement rule objects 150 may include criteria for determining whether components of an advertisement satisfy one or more policies of the online system 101. In some embodiments, the online system 101 also includes one or more component rule objects 140, which store information describing how to identify one or more components of an advertisement and determining whether a component satisfies one or more policies of the online system 101. An approved advertisement object 170 stores information describing characteristics of an advertisement determined to satisfy at least a threshold number of policies of the online system 101 by an advertisement approval module 130. The online system 101 and the previously identified objects are further described below in conjunction with FIG. 2.

### Online System Architecture

FIG. 2 is a block diagram of one embodiment of a system architecture of an online system 101 for approving advertisements. In the embodiment shown by FIG. 2, the online system 101 includes an external system interface 110, an advertisement approval module 130, a user profile store 210, a web server 230, an advertisement store 240, and an advertisement (“ad”) component store 250. In other embodiments, the online system 101 may include additional, fewer, or different modules for various applications. Conventional components such as network interfaces, security mechanisms, load balancers, failover servers, management and network operations consoles, and the like are not shown so as to not obscure the details of the system.

The online system 101 allows users to communicate or otherwise interact with each other and access content. Each user of the online system 101 is associated with a user profile object stored in the user profile store 210. A user profile object describes a user of the online system 101. For example, a user profile object includes biographic, demographic, and other types of descriptive information associated with a user, such as work experience, educational history, gender, sexual preferences, hobbies or preferences, location, and the like.

The web server 230 links the online system 101 via a network 220 to one or more client devices 120; the web server 230 serves web pages, as well as other content, such as JAVA®, FLASH®, XML, and so forth. The web server 230 receives and routes messages between the online system 101 and the client devices 120. These messages may be instant messages, queued messages (e.g., email), text and SMS (short message service) messages, or any other suitable messaging technique.

Interactions between client devices 120 and the online system 101 are typically performed via a network 220. In one embodiment, the network 220 uses standard communications technologies and/or protocols. Thus, the network 220 may include communication channels using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Examples of networking protocols used on the network 220 include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. Data exchanged over the network 220 may be represented using technologies and/or formats including hypertext markup language (HTML), extensible markup language (XML), etc. In addition, all or some of the communication channels may be encrypted using conventional encryption technologies such as secure sockets layer (SSL), transport layer security (TLS), virtual private networks (VPNs), Internet Protocol security (IPsec), etc. In another embodiment, custom and/or dedicated data communication technologies may be used in addition to, or instead of, those described above. Depending upon the embodiment, the network 220 may also include links to other networks.

The advertisement store 240 of the online system 101 stores information describing advertisements, such as advertisement objects 160 associated with various advertisements. Each advertisement object 140 is associated with a user, such as an advertiser. An advertisement object 140 may be manually created through an interface provided by the online system 101. Alternatively, one or more advertisement objects 140 may be created using an application programming interface (API). After an advertisement object 140 is created, it is reviewed before being presented to other users of the online system 101. In some embodiments, the advertisement store 240 stores advertisement objects 160 satisfying at least a threshold number of policies enforced by the online system 101 specifying content of advertisements and does not store advertisement objects 140 that do not satisfy at least the threshold number of policies enforced by the online system 101. Additionally, the online system 101 may remove advertisement objects 140 from the advertisement store 240 after a specified time interval, which may be included in the advertisement. Other embodiments maintain advertisement objects 140 that do not do not satisfy at least a threshold number of policies enforced by the online system 101 in the advertisement store 240 or do not limit a duration the advertisement objects 140 are stored in the advertisement store 240.

In some embodiments, the online system 101 also includes an ad component store 250 that stores information describing comparisons of advertisement components to one or more policies enforced by the online system 101. The ad component store 250 also stores information indicating whether an advertisement component satisfies one or more policies of the online system 101, such as the results of analysis of an advertisement component by the advertisement approval module 130. In some embodiments, the ad component store 250 stores the entire component and an indication of whether the component satisfies one or more policies enforced by the online system 101. Other embodiments store a representation of the components such as a hash or a signature describing a component.

The advertisement approval module 130 regulates content included in advertisements and determines whether an advertisement or components of an advertisement comply with one or more policies enforced by the online system 101. In the example of FIG. 2, the advertisement approval module 130 includes an advertisement divider module 260, a component search module 270, a component review module 280, a component rule store 285, an advertisement review module 290, and an advertisement rule store 295. In other embodiments, different and/or additional components may be included in the advertisement approval module 130. Details of the advertisement approval module 130 are further described herein.

### Advertisement Divider

The advertisement divider module 260 partitions an advertisement into one or more components. In one embodiment, the advertisement divider module 260 partitions an advertisement into one or more of: a title, a body, an image, a landing page, an audience, an account, and a campaign. The title provides a brief description of the advertisement. The body, or text, of the advertisement provides details about a product, service, or other content associated with the advertisement. The image is graphical data displayed by the advertisement. A landing page, or destination, is a web page, application, web site, or other network destination to which a user is directed when the user accesses the advertisement. The audience component includes characteristics of users to be presented with the advertisement; for example, the audience component includes targeting criteria identifying characteristics of users eligible to be presented with the advertisement. An account identifies a user, such as an advertiser, associated with the advertisement. The campaign includes other information such as the timeframe during which an advertisement is presented, a budget for presenting the advertisement, the amount of money the online system 101 charges for presenting the advertisement to users, or other suitable information. In other embodiments, different and/or additional components may be identified from an advertisement.

When a component of an advertisement is identified, the component search module 270 determines whether a component from another advertisement matching, or similar to, the component satisfies one or more policies of the online system 101 based on information in the ad component store 250. If a match is found, the advertisement approval module 130 retrieves data associated with the matching or similar component and uses the data associated with the matching or similar component to indicate whether the component of the advertisement satisfies one or more policies enforced by the online system 101. The component search module 270 may use different processes to determine the similarity between components. For example, components may be stored in association with a unique ID that can be used to determine matches or similarities. For example, a threshold level of similarity may be specified so that a stored component having at least the threshold similarity to a component is identified as a match for the component. For example, whether a color image satisfies one or more policies of the online system 101 may be used to indicate whether a black and white image having the same content satisfies one or more policies of the online system 101.

The component search module 270 may use different processes for identifying stored components based on a type of a component. For example, to determine if the text of two advertisements are equivalent, keyword matching may be used. In one embodiment, the component search module 270 may require both texts to have the exact same words. In another embodiment, the component search module 270 identifies a stored component having at least a threshold number of words matching words in a component.

To determine if a component of an advertisement object 140 specifying a landing page matches a landing page of another advertisement, the component search module 270 may compare the uniform resource locators (URLs) of the landing pages. If the URLs specify the same web page or other network destination, the component specifying the landing page is determined to match the landing page of the other advertisement. In some embodiments, the component search module 270 determines whether the domain names of the different landing pages match, and identifies landing pages as matching if the domain names match. For example, the landing pages “domain1.com/index.html” and “domain1.com/default.asp” are determined to match because both have the domain name “domain1.com.” In other embodiments, the component search module 270 may access different landing pages to determine if the content of the landing pages is similar or matching.

A component of an advertisement may be an image presented when an advertisement is displayed. To determine whether an image component matches a stored image component, a signature or hash may be generated and compared to a database of image signatures or hashes. In one embodiment, images with similar characteristics are assigned similar hashes. Hence, if the difference between the hashes of two images is below a threshold, the component search module 270 determines the two images match. In other embodiments one or more image processing methods are used to determine if two images are match.

In one embodiment, the component search module 270 searches components previously analyzed using processes having a threshold measure of complexity. As an example, determining that an image references alcoholic beverages is difficult and may consume significant computational resources if reviewed multiple times. However, a title is usually short and conveys a clear message, so limited computational resources are used when analyzing a title. Hence, storing results of image analysis for a reference to alcoholic beverages provides a savings in the time for analyzing an advertisement while storing results of analysis of a title provides limited, if any, reduction in advertisement analysis time. Hence, analyzing components of advertisements and storing the results of the analysis expedites approval of advertisements and results in a more consistent advertisement review process.

### Advertisement Component Analysis

The component review module 280 identifies components of an advertisement. In some embodiments, the component review module 280 assigns tags from a pre-determined list of tags or “ground truths” stored in the component rule store 285. Tags describe content features or attributes of the advertisement components. Hence, the tags maintained by the component rule store 285 describe characteristics of advertisement components. For example, an image including a picture of a beer mug may be tagged as “Alcohol Reference.”

In some embodiments, tags are policy independent. As tags describe a component and do not specify whether a component satisfies a policy of the online system 101, if a policy changes, the tags associated with an advertisement object 140 may remain unchanged. For example, if a policy in the online system 101 specifying rejection of advertisements related to paintball is removed, components identified as related to paintball remain tagged as “Paintball Reference.” When the advertisement approval module 130 reviews an advertisement object 140, the advertisement object 140 is not rejected for having the “Paintball Reference” tag, despite being rejected for having the “Paintball Reference” tag before the policy was removed.

In some embodiments, if analysis of a component is complex or if the component review module 280 determines the component needs further review, the component review module 280 may suggest manual review of the component. For example, the component review module 280 assigns a special tag, such as a “Flagged for Review” tag, to a component to identify the component for manual review. In some embodiments, tags associated with a component by a human reviewer are differentiated from tags assigned to the component by the component review module 280. For example if an image contains an alcohol reference, the component review module 280 assigns the component a “GT_ALCOHOL_REFERENCE” tag and the human reviewer assigns the component a “REP_ALCOHOL_REFERENCE” tag.

In some embodiments, if the component review module 280 identifies a component for manual review, the component is sent to multiple human reviewers (e.g., five reviewers). In one embodiment, a tag is associated with a component if at least a threshold number or a threshold percentage of the reviewers assign the tag to the component. For example, if four out of five reviewers tag an image as “Suitable for All” and a single reviewer tags the image as “Revealing Body Parts,” the image is assigned a tag of “Suitable for All.” In another embodiment, the threshold number or percentage of reviewers to assign a tag to a component varies depending on the type of tag. Each tag may be associated with a different threshold number or percentage of reviewers to assign the tag to a component depending on a risk factor associated with the tag. The risk factor may provide a metric of a likelihood of users identifying content associated with the tag as offensive. For example, if five reviewers analyze a component, the component review module 280 assigns a tag to a component having a medium risk factor if two of the five reviewers assign the tag to the component and assigns a tag to a component having a high risk factor if a single reviewer assigns the tag to the component.

In some embodiments, if a human reviewer is unable to determine a most appropriate tag for a component, the component review module 280 assigns a tag to the component requesting generation of a new tag. For example, a “REP_NEED_BAD_TAG” tag is associated with a component for which a tag cannot be identified. In one embodiment, the component review module 280 periodically reviews stored components associated with a “REP NEED_BAD_TAG” tag to determine whether to create new tags.

Advertisement Review for Compliance with Policies Enforced by the Online System

In some embodiments, after the component review module 280 reviews components of an advertisement, the advertisement review module 290 determines whether the advertisement complies with one or more policies of the online system 101 included in the advertisement rule store 295 based on the characteristics of the components. Alternatively, the advertisement review module 290 determines whether an advertisement complies with one or more policies stored in the advertisement rule store 295 independent of the review of the advertisement's components by the component rule module 280. The advertisement review module 290 retrieves a policy from the advertisement rule store 295 and determines whether content included in an advertisement complies with the retrieved policy. Example policies included in the advertisement rule store 295 prevent association of certain landing pages with advertisements presented by the online system 101 (e.g., landing pages identifying certain domains), inclusion of images of certain types of content in advertisements presented by the online system 101, and inclusion of certain words or phrases in advertisements presented by the online system 101. Hence, maintaining and enforcing policies allows the online system 101 to regulate content included in advertisements presented via the online system 101 to prevent presentation of offensive content to online system users or to otherwise prevent advertisements presented via the online system 101 from impairing user interaction with the online system 101. In some embodiments, the advertisement review module 290 determines an advertisement does not comply with one or more policies of the online system 101 if at least one component of the advertisement is associated with a tag included on a blacklist maintained by the advertisement review module 290 or by the advertisement rule store 295. In other embodiments, an advertisement is determined not to comply with one or more policies enforced by the online system 101 if at least a threshold number of components of the advertisement are associated with tags included on a blacklist.

In another embodiment, the advertisement review module 290 determines whether an advertisement complies with one or more policies enforced by the online system 101 based on multiple characteristics of components of an advertisement. For example, the advertisement review module 290 determines an advertisement including an image tagged as “Alcohol Reference” and a specified target audience of all users does not comply with a policy enforced by the online system 101 limiting presentation of advertisements including references to alcohol to users with ages within a specified range (e.g., over 21 years old). However, if another advertisement includes an “Alcohol Reference” tagged image and specifies a target audience of users over 21 years old, the advertisement review module 290 determines the advertisement complies with a policy enforced by the online system 101. In another embodiment, the advertisement review module 290 approves an advertisement including an auto-approve tag associated with a component, regardless of tags associated with other components of the advertisement.

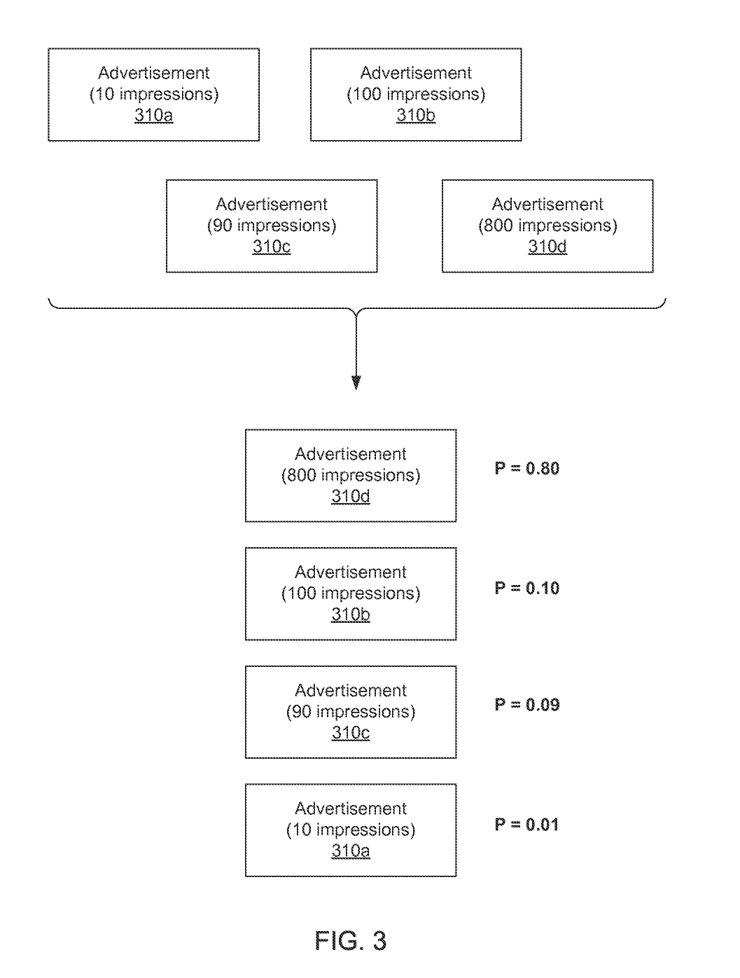

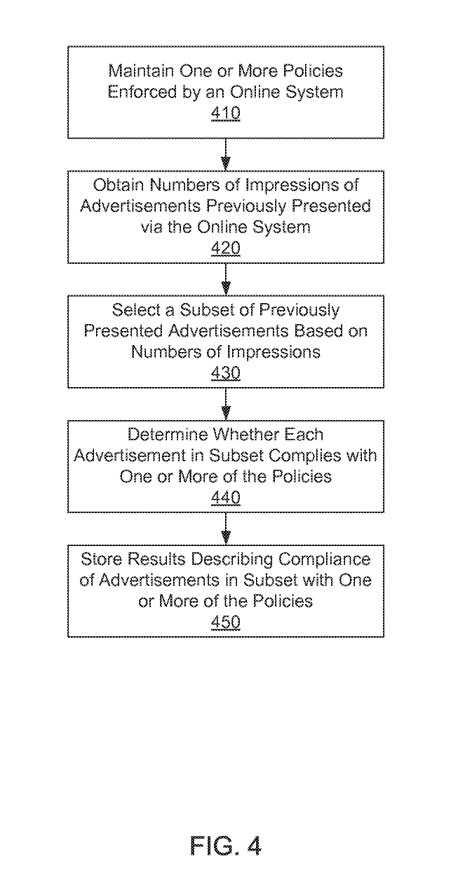

As further described below in conjunction with FIGS. 3 and 4, the advertisement review module 290 identifies a subset of advertisements previously presented to online system users to be additionally evaluated for compliance with policies enforced by the online system 101. In one embodiment, after advertisements are presented by the online system 101, the advertisement store 240 includes information identifying a number of times the advertisements were presented to online system users (i.e., a number of impressions of the advertisements). For example, the online system 101 increments a value associated with an advertisement in the advertisement store 240 each time the advertisement is presented to a user of the online system. As further described below in conjunction with FIGS. 3 and 4, the advertisement review module 290 identifies the subset of previously presented advertisements based at least in part on the number of impressions of previously presented advertisements. For example, previously presented advertisements having a larger number of impressions have a higher probability of being selected. As another example, the advertisement review module 290 ranks previously presented advertisements based on their associated numbers of impressions and selects previously presented advertisements for inclusion in the subset. Previously-presented advertisements in the subset are again evaluated for compliance with one or more of the policies enforced by the online system 101, and the results of the evaluation are stored. Based on the results of the additional evaluation of the previously presented advertisements, the online system 101 may modify one or more models or processes used by the advertisement review module 290 to determine whether an advertisement complies with one or more policies enforced by the online system 101 or identify characteristics of advertisements that do not comply with one or more policies of the online system. Selection and evaluation of previously presented advertisements is further described below in conjunction with FIG. 4.

### Additionally Reviewing Previously Presented Advertisements

FIG. 3 is a process flow diagram illustrating selection of previously presented advertisements for additional evaluation for compliance with one or more policies enforced by the online system 101, according to one embodiment. In the example shown by FIG. 3, advertisements 310a, 310b, 310c, 310d (also individually and collectively referred to using reference number 310) have previously been presented to online system users, and the online system 101 includes information identifying a number of impressions of each of advertisement 310a, 310b, 310c, 310d. In some embodiments, the online system 101 selects one or more previously presented advertisements through a weighted random sampling with weights associated with each previously presented advertisement based on a number of impressions of the advertisements. For example, the online system 101 determines a weight for a previously presented advertisement as a ratio of a number of impressions during a specified time interval of the advertisement to a total number of impressions of advertisements during the specified time interval (e.g., a ratio of number of impressions of the advertisement within a day or week from the current date to a total number of impressions of advertisements within the day or week from the current date).

In the example of FIG. 3, advertisement 310d has 800 impressions, with 1000 total number of impressions of advertisements 310a, 310b, 310c, 310d, so advertisement 310d is associated with a weight of 800/1000, or 0.8. Similarly, advertisement 310b in the example of FIG. 3 has 100 impressions, so it is associated with a weight of 100/1000, or 0.1. Hence, when selecting previously presented advertisements for inclusion in a subset, advertisement 310d has an 80% likelihood of being selected, while advertisement 310b has a 10% likelihood of being selected. Associating weights with different advertisements 310 increases the likelihood of the online system 101 including advertisements that have been frequently presented to its users for additional evaluation for compliance with policies enforced by the online system 101.

FIG. 4 illustrates one embodiment of a method for additionally evaluating previously presented advertisements for compliance with policies enforced by the online system 101 based on impressions of the previously presented advertisements. As described above in conjunction with FIG. 2, the online system 101 maintains 410 and enforces one or more policies regulating content included in advertisements presented by the online system 101. For example, policies limit inclusion of certain images or phrases to advertisements presented to specific online system users having certain characteristics, prevent presentation of advertisements having certain subject matter to online system users having certain characteristics 101, prevent inclusion of certain words or phrases in advertisements presented via the online system 101, or prevent inclusion of certain types of images in advertisements presented via the online system 101. Advertisements received by the online system 101 are evaluated for compliance with at least a threshold number of the policies maintained 410 by the online system 101, and advertisements complying the with the threshold number of the policies are presented to online system users via the online system 101.

The online system 101 also maintains a number of times each advertisement is presented by the online system 101 to one or more users, or “impressions” of each advertisement. A number of impressions is associated with an advertisement by the online system 101, and the number of impressions is modified as the advertisement is presented. The online system 101 may maintain a total number of impressions of an advertisement, as well as impressions of the advertisement during different time intervals.

To more accurately determine whether advertisements comply with one or more enforced policies, the online system 101 obtains 420 numbers of impressions of advertisements previously presented to users by the online system 101. The numbers of impressions may be obtained 420 from information stored by the online system 101 or retrieved from a source external to the online system 101. In one embodiment, the online system 101 obtains 420 a total number of impressions of various advertisements previously presented by the online system 101 since the advertisements were received by the online system 101. Alternatively, the online system 101 obtains 420 a number of impressions of various advertisements during a specified time interval (e.g., a week, a month, a day). Additionally, the online system 101 may obtain 420 numbers of impressions of advertisements having certain components or characteristics (e.g., advertisements associated with a particular user or location, advertisements including content relating to specific subject matter).

Based on the numbers of impressions of the previously presented advertisements, the online system 101 selects 430 a subset of the previously presented advertisements. For example, as described above in conjunction with FIG. 3, the online system 101 determines a weight for each previously presented advertisement in the subset based on a number of impressions of a previously presented advertisement and the total number of impressions of previously presented advertisements. In one embodiment, the weight for a previously presented advertisement in the subset is a ratio of the number of impressions of the previously presented advertisement to a total number of impressions of previously presented advertisements. A weight associated with a previously presented advertisement may indicate the probability that the previously presented advertisement is selected 430 for inclusion the subset.

Alternatively, the online system 101 may rank previously presented advertisements, or a set of previously presented advertisements, based on their associated number of impressions and select 430 the subset of previously presented advertisements based on the ranking For example, previously presented advertisements having at least a threshold position in the ranking are selected 430 for inclusion in the subset. Hence, the online system 101 may select 430 more frequently presented advertisements for the subset.

The online system 101 determines 440 whether each previously presented advertisement in the subset complies with one or more of the policies enforced by the online system 101 as described above in conjunction with FIG. 2. In one embodiment, compliance of a previously presented advertisement with an advertising policy is determined 440 through a different process than an earlier determination of compliance with one or more policies enforced by the online system 101. For example, if one or more machine learned models were previously applied to a previously presented advertisement to determine whether the advertisement complies with one or more policies enforced by the online system 101, a human reviewer determines 440 whether the previously presented advertisement complies with one or more policies enforced by the online system 101. As another example, if a human reviewer determined 440 whether the previously presented advertisement complies with one or more policies enforced by the online system 101, if the previously presented advertisement is included in the subset, one or more machine learned models are applied to the previously presented advertisement to determine 440 whether the previously presented advertisement complies with the one or more policies enforced by the online system 101. Alternatively, compliance of a previously presented advertisement with an advertising policy can be determined 440 through a same or similar process as an earlier determination of compliance with one or more policies enforced by the online system 101.

Results identifying compliance of different advertisements in the subset with policies enforced by the online system 101 are stored 450 by the online system 101. In one embodiment, the results identify a previously presented advertisement and identify one or more policies with which the previously presented advertisement was determined 440 not to comply. Alternatively, the results identify the previously presented advertisement and include values indicating whether the previously presented advertisement was determined 440 to comply with different policies enforced by the online system 101. Additionally, the results may identify specific components of a previously presented advertisement determined 440 not to comply with a policy enforced by the online system 101 as well as identify the policy with which the component was determined 404 not to comply.

Based on the results, the online system may modify one or more models applied to advertisements to determine if the advertisements comply with one or more policies enforced by the online system 101. For example, the results may be used to modify one or more weights associated with components of advertisements when compared to policies enforced by the online system. As another example, the results may be used to identify additional components of advertisements indicating whether an advertisement complies with a policy enforced by the online system 101, so the online system 101 may modify a model applied to advertisements to determine whether the advertisements comply with the policy to include the component. In other embodiments, the online system 101 generates one or more reports from the results providing information about advertisements that do not comply with one or more policies enforced by the online system 101. For example, the report identifies policies with which a previously presented advertisement did not comply, as well as components of the advertisement determined not to comply with the policies. In some embodiments, the online system 101 prevents subsequent presentation of a previously presented advertisement that was determined 440 not to comply with one or more policies enforced by the online system 101. For example, the online system 101, identifies advertisements from the subset determined to violate one or more policies as ineligible for subsequent presentation to the user or remove may be automatically removed or flagged for removal from the group of advertisements that continue to be presented to users. A flag, a field, or other information may be associated with a previously presented advertisement determined 440 not to comply with one or more policies enforced by the online system 101 to prevent further presentation of the previously presented advertisement (e.g., identify the previously presented advertisement as ineligible for presentation, or identify the previously presented advertisement for removal from the online system 101).

### SUMMARY

The foregoing description of embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of embodiments is intended to be illustrative, but not limiting, of the scope of the patent rights, which is set forth in the following claims.

What is claimed is:

1. A method comprising:
maintaining one or more policies at an online system, the one or more policies regulating content included in advertisements presented by the online system;
obtaining information identifying a numbers of impressions of each of a plurality of advertisements presented to one or more users of an online system;
selecting a subset of the advertisements from the plurality of advertisements based at least in part on the numbers of impressions of the advertisements of the plurality of advertisements;
determining whether each advertisement in the subset complies with one or more of the one or more policies enforced by the online system; and
storing results describing the determined compliance of the advertisements in the subset with the one or more policies enforced by the online system.

2. The method of claim 1, wherein the plurality of advertisements have previously been determined to comply with the one or more policies enforced by the online system by applying one or more models to advertisements in the plurality of advertisements, and further comprising:
modifying one or more of the models based at least in part on the results.

3. The method of claim 2, wherein modifying one or more of the models based at least in part on the results comprises:
including one or more additional components of advertisements in a model based on the results.

4. The method of claim 1, further comprising:
generating a report from the results, the report describing advertisements in the subset determined not to comply with one or more of the policies enforced by the online system.

5. The method of claim 4, wherein the report includes information identifying one or more policies with which an advertisement in the subset was determined to not comply and one or more components of the advertisement determined not to comply with a policy.

6. The method of claim 1, wherein selecting the subset of the advertisements from the plurality of advertisements based at least in part on numbers of impressions of each advertisement in the plurality of advertisements comprises:
determining weights associated with the plurality of advertisements, a weight associated with an advertisement in the plurality of advertisements based at least in part on a number of impressions of the advertisement in the plurality of advertisements; and
selecting the subset of the advertisements based at least in part on the weights.

7. The method of claim 6, wherein the weight associated with the advertisement in the plurality of advertisements is a ratio of the number of impression of the advertisement to a total number of impressions of advertisements in the plurality of advertisements.

8. The method of claim 7, wherein the weight associated with the advertisement is a probability of selecting the advertisement for the subset of advertisements.

9. The method of claim 1, wherein selecting the subset of the advertisements from the plurality of advertisements based at least in part on numbers of impressions of each advertisement in the plurality of advertisements comprises:
ranking the advertisements based at least in part on the number of impressions; and
selecting the subset of the advertisements based at least in part on the ranking.

10. The method of claim 1, further comprising:
storing information identifying one or more of the advertisements in the subset determined not to comply with one or more policies enforced by the online system based on the results.

11. A computer program product comprising a computer readable storage medium having instructions encoded thereon that, when executed by a processor, cause the processor to:
maintain one or more policies at an online system, the one or more policies regulating content included in advertisements presented by the online system;
obtain information identifying numbers of impressions of a plurality of advertisements presented to one or more users of an online system;
select a subset of the advertisements from the plurality of advertisements based at least in part on numbers of impressions of each advertisement in the plurality of advertisements;
determine whether each advertisement in the subset complies with one or more of the one or more policies enforced by the online system; and
store results of describing compliance of advertisements in the subset with the one or more policies enforced by the online system.

12. The computer program product of claim 11, wherein the plurality of advertisements have previously been determined to comply with the one or more policies enforced by the online system by applying one or more models to advertisements in the plurality of advertisements, and the computer readable storage medium further has instructions encoded thereon that, when executed by the processor, cause the processor to:
modify one or more of the models based at least in part on the results.

13. The computer program product of claim 12, wherein modify one or more of the models based at least in part on the results comprises:
include one or more additional components of advertisements in a model based on the results.

14. The computer program product of claim 11, wherein the computer readable storage medium further includes instructions that, when executed by the processor, cause the processor to:
generate a report from the results, the report describing advertisements in the subset determined not to comply with one or more of the policies enforced by the online system.

15. The computer program product of claim 14, wherein the report includes information identifying one or more policies with which an advertisement in the subset was determined to not comply and one or more components of the advertisement determined not to comply with a policy.

16. The computer program product of claim 11, wherein select the subset of the advertisements from the plurality of advertisements based at least in part on numbers of impressions of each advertisement in the plurality of advertisements comprises:
determine weights associated with the plurality of advertisements, a weight associated with an advertisement in the plurality of advertisements based at least in part on a number of impressions of the advertisement in the plurality of advertisements; and
select the subset of the advertisements based at least in part on the weights.

17. The computer program product of claim 16, wherein the weight associated with the advertisement in the plurality of advertisements is a ratio of the number of impression of the advertisement to a total number of impressions of advertisements in the plurality of advertisements.

18. The computer program product of claim 17, wherein the weight associated with the advertisement is a probability of selecting the advertisement for the subset of advertisements.

19. The computer program product of claim 11, wherein select the subset of the advertisements from the plurality of advertisements based at least in part on numbers of impressions of each advertisement in the plurality of advertisements comprises:
rank the advertisements based at least in part on the number of impressions; and
select the subset of the advertisements based at least in part on the ranking.

20. The computer program product of claim 19, wherein the computer readable storage medium further has instructions encoded thereon that, when executed by the processor, cause the processor to:
store information identifying one or more of the advertisements in the subset determined not to comply with one or more policies enforced by the online system based on the results.
